(19) United States
(12) Patent Application Publication
(10) Pub. No.: US 2022/0012821 A1
(43) Pub. Date: Jan. 13, 2022

(54) PREDICTION OF A WIND FARM ENERGY PARAMETER VALUE

(71) Applicant: Siemens Gamesa Renewable Energy Service GmbH, Hamburg (DE)

(72) Inventors: Hennig Harden, Hamburg (DE); Ali Hadjihosseini, Hamburg (DE)

(21) Appl. No.: 17/290,520

(22) PCT Filed: Oct. 23, 2019
(86) PCT No.: PCT/EP2019/078798

§ 371 Date: Apr. 30, 2021

(30) Foreign Application Priority Data
Nov. 6, 2018 (DE) 10 2018 008 700.0

(51) Int. Cl. G06Q 50/06; G05B 13/02; F03D 7/02; F03D 7/04; G01W 1/10

(52) U.S. Cl. CPC G06Q 50/06; G05B 13/027; G01W 1/10; F03D 7/048; F03D 7/0284

(57) ABSTRACT

A method for predicting an energy parameter value of at least one wind farm that is connected to an electricity grid via a grid connection point and which includes at least one wind energy installation. The method includes detecting values of input parameters that include state parameters, control parameters and/or service parameters of the wind farm, in particular of the wind energy installation and/or of the grid connection point, and/or of at least one facility external to the wind farm, and predicting the energy parameter value on the basis of the detected input parameter values and a machine-learned relationship between the input parameters and the energy parameter.

### CROSS-REFERENCE TO RELATED APPLICATIONS

This application is a national phase application under 35 U.S.C. § 371 of International Patent Application No. PCT/EP2019/078798, filed Oct. 23, 2019 (pending), which claims the benefit of priority to German Patent Application No. DE 10 2018 008 700.0, filed Nov. 6, 2018, the disclosures of which are incorporated by reference herein in their entirety.

### TECHNICAL FIELD

The present invention relates to a method and system for predicting an energy parameter value of at least one wind farm which is connected to an electricity grid via a grid connection point and which comprises at least one wind energy installation, as well as to a computer program product for carrying out the method.

### BACKGROUND

In particular for the grid management of electricity grids with integrated wind farms, a prediction of energy parameter values of the wind farms is important, for example, in order to maintain appropriate reserves, to distribute loads or use of capacities and the like, in particular in order to improve grid stability.

### SUMMARY

It is an object of the present invention to improve the prediction of an energy parameter value of one or more wind farms.

This object is solved by a method as disclosed herein, and by a system and a computer program product for carrying out one of the methods described herein.

According to one embodiment of the present invention, one or more wind farms are (each) temporarily or permanently connected to an electricity grid via a grid connection point.

In one embodiment, the wind farm or one or more of the wind farms (each) comprises/comprise one or more wind energy installation(s), each of which in turn has/have, in one embodiment, a rotor, which, in one embodiment, has at least one rotor blade and/or at most six rotor blades and/or an at least substantially horizontal axis of rotation or (longitudinal) rotor axis, and/or a generator which, in particular, is coupled thereto and/or which is temporarily or permanently connected to the (respective) grid connection point, in particular via at least one transformer.

According to one embodiment of the present invention, values of input parameters (“input parameter values”) are detected which may comprise state parameters (or state parameter values), control parameters (or control parameter values) and/or service parameters (or service parameter values) of the wind farm or wind farms, in particular of the wind energy installation or wind energy installations and/or the (respective) grid connection point, and/or of one or more facilities which are external to the wind farm and/or independent of, and/or spaced apart from, the wind farm, or may in particular consist of these. In one embodiment, this detecting may comprise, or may in particular be, a determining, in particular a measuring, a processing, for example a filtering, an integrating, a classifying or the like, and/or an obtaining of input parameter values.

In one embodiment, input parameters (or the input parameters or input parameter values or the input parameter values) (or at least part of these) are detected in a continuous manner. By means of this, in one embodiment, a prediction accuracy and/or a prediction currentness can be improved.

In addition or as an alternative, in one embodiment, input parameters (or the input parameters or input parameter values or the input parameter values) (or at least part of these) are detected in a discontinuous manner, in particular in a cyclical or a periodical manner. By means of this, in one embodiment, the amount of data and/or the overhead of obtaining measurements can advantageously be reduced.

According to one embodiment of the present invention, a value of a one-dimensional or multidimensional energy parameter (“energy parameter value”) is predicted on the basis of these detected input parameter values and a machine-learned relationship between the input parameters and the energy parameter.

By means of this, in one embodiment, the generation of a prediction, in particular the amount of time required for this, and/or the quality of the prediction can be improved.

In one embodiment, the (predicted) input parameter (value) depends on an electrical energy, in particular an electrical power, of the (respective) wind farm that the wind farm provides (or is expected to provide) or is able to provide (or is expected to be able to provide) at the (respective) grid connection point or that the wind farm feeds into the electricity grid or is able to feed into the electricity grid (or is expected to feed into the electricity grid or is expected to be able to feed into the electricity grid) at the (respective) grid connection point, or it may in particular indicate this.

By means of this, in one embodiment, a grid management or a grid control system of the electricity grid can be advantageously implemented, and, in particular, individual components of the electricity grid, in one embodiment the wind farm or one or more of the wind farms, in particular their wind energy installation or wind energy installations and/or their grid connection point or grid connection points, can be controlled, in particular controlled with feedback, on the basis of the predicted energy parameter value or values. In accordance with this, according to one embodiment of the present invention, protection is sought for a method, a system or a computer program product for controlling (a grid management system of) the electricity grid on the basis of the predicted energy parameter value, or the method comprises the step of: controlling, in particular controlling with feedback, (a grid management system) of the electricity grid on the basis of the predicted energy parameter value, or the system comprises means for controlling, in particular with feedback, (a grid management system) of the electricity grid on the basis of the predicted energy parameter value.

In one embodiment, at least one input parameter value is determined on the basis of measured electrical, mechanical, thermal and/or meteorological data, i.e. in particular on the basis of electrical, mechanical, thermal and/or meteorological data measured with the aid of the (respective) wind farm and/or at the (respective) wind farm, in particular in the (respective) wind farm, in particular its wind energy installation or installations and/or its grid connection point, and/or with the aid of the (respective) facility external to the wind farm and/or at the (respective) facility external to the wind farm, in particular in the (respective) facility external to the wind farm, in particular a component of the electricity grid (external to the wind farm) and/or a meteorological station, and such data can in particular form input parameter values or the latter can depend on such data.

In addition or as an alternative, in one embodiment, at least one input parameter value is determined on the basis of predicted electrical, mechanical, thermal and/or meteorological data, i.e. in particular on the basis of electrical, mechanical, thermal and/or meteorological data predicted with the aid of the (respective) wind farm and/or at the (respective) wind farm, in particular in the (respective) wind farm, in particular its wind energy installation or installations and/or its grid connection point, and/or with the aid of the (respective) facility external to the wind farm and/or at the (respective) facility external to the wind farm, in particular in the (respective) facility external to the wind farm, in particular a component of the electricity grid (external to the wind farm), a meteorological station and/or a weather forecast (or weather forecast facility), and such data can in particular form input parameter values or the latter can depend on such data.

An input parameter (value) can in particular comprise, or in particular be, a mechanical, thermal and/or an electrical state parameter or state parameter value, in particular a mechanical, thermal and/or an electrical status parameter or status parameter value, and/or a mechanical, thermal and/or an electrical control parameter or control parameter value, in particular a mechanical, thermal and/or an electrical feedback control parameter or feedback control parameter value, of the rotor and/or of the generator of the wind energy installation or of one or more of the wind energy installations, an electrical and/or a thermal state parameter or state parameter value, in particular an electrical and/or a thermal status parameter or status parameter value, and/or an electrical and/or a thermal control parameter or control parameter value, in particular an electrical and/or a thermal feedback control parameter or feedback control parameter value, of one or more transformer or transformers, and/or a meteorological state parameter, in particular wind speed or wind speeds, in particular wind force or wind forces and/or wind direction or wind directions, of one or more meteorological stations and/or weather forecast or weather forecasts and/or weather forecast facility or weather forecast facilities, in particular at one or more meteorological stations and/or weather forecast or weather forecasts and/or weather forecast facility or weather forecast facilities. In one embodiment, at least one input parameter (or input parameter value) is detected with the aid of a condition monitoring system of the corresponding wind farm, in particular with the aid of a condition monitoring system of the corresponding wind energy installation.

By means of this, in one embodiment, in particular if two or more of the variants mentioned above are combined, the quality of the prediction of the respective energy parameter value can be improved.

In addition or as an alternative, in one embodiment, at least one input parameter value is determined on the basis of a planned maintenance of the wind farm or of one or more of the wind farms, in particular of the wind energy installation or wind energy installations, in particular on the basis of a planned point in time and/or a planned time period for the maintenance. In one embodiment, the input parameter value or at least one input parameter value determined on the basis of planned maintenance is updated one or more times, in one embodiment in an event based manner and/or cyclically, in particular continuously, in one embodiment permanently, and in one embodiment on the basis of a respective maintenance currently planned, or on the basis of an updated planned maintenance.

In one embodiment, by taking planned maintenance into account, the quality of the prediction can be (further) improved. In one embodiment, by carrying out an update, a postponement of planned maintenance due to unforeseen service calls or other events can be taken into account.

In one embodiment, the energy parameter value is predicted for at least two different time horizons.

In one embodiment, the energy parameter value is predicted for at least one time horizon of a maximum of 5 minutes, i.e. in particular for a point in time and/or a period of time that is at most 5 minutes in the future.

In addition or as an alternative, in one embodiment, the energy parameter value is predicted for at least one time horizon of at least 5 minutes, in particular at least 10 minutes, and a maximum of 30 minutes, in particular a maximum of 20 minutes, i.e. in particular for a point in time and/or a period of time which is at least 5 or 10 minutes in the future and a maximum of 20 or 30 minutes in the future.

In addition or as an alternative, in one embodiment, the energy parameter value is predicted for at least one time horizon of at least 15 minutes, in particular at least 60 minutes, and/or a maximum of 72 hours, in particular a maximum of 48 hours, in one embodiment a maximum of 24 hours, in particular a maximum of 12 hours, i.e. in particular for a point in time and/or a period of time which is at least 15 or 60 minutes in the future and/or a maximum of 12, 24, 48 or 96 hours in the future.

By means of this, in one embodiment, in particular if two or more of the variants mentioned above are combined, the use of the prediction of the energy parameter value, in particular a control of the wind farm or wind farms and/or of the electricity grid on the basis of the prediction of the energy parameter value, in particular a feedback control of the wind farm or wind farms and/or of the electricity grid on the basis of the prediction of the energy parameter value, can be improved.

In one embodiment, the input parameter value or one or more of the input parameter values and/or the energy parameter value are transmitted via a VPN gateway, in particular a web-based VPN, and/or to a cloud or a data cloud or a computer cloud, in particular a virtual private cloud, and/or from a cloud or a data cloud or a computer cloud, in particular a virtual private cloud, in one embodiment to the wind farm or to one or more of the wind farms, and/or from the wind farm or from one or more of the wind farms, and/or to the facility external to the wind farm or wind farms or to one or more of the facilities external to the wind farm or wind farms, and/or from the facility external to the wind farm or wind farms or from one or more of the facilities external to the wind farm or wind farms, and/or to a grid management system of the electricity grid or the grid management system of the electricity grid and/or to an artificial neural network and/or from an artificial neural network or from the artificial neural network which implements the relationship.

By means of this, in one embodiment, an artificial intelligence that predicts the energy parameter value on the basis of the detected input parameter values and the relationship learned by machine learning can access data in a particularly advantageous manner, in particular data of wind farms with a spatial distance therebetween, as well as facilities external to the wind farm, and/or can make the energy parameter value available to the grid management system in a particularly advantageous manner.

In one embodiment, the relationship between the input parameters and the energy parameter continues to be learned by machine learning even during the operation of the at least one wind farm, in particular during the normal operation of the at least one wind farm.

In addition or as an alternative, in one embodiment, the relationship is implemented with the aid of an artificial neural network.

In addition or as an alternative, in one embodiment, the relationship is learned by machine learning on the basis of a comparison of detected values and predicted values of the energy parameter.

By means of this, in one embodiment, in particular if two or more of the variants mentioned above are combined, the relationship between the input parameters and the energy parameter and thereby in particular the quality of the prediction of the energy parameter value can be improved.

According to an embodiment of the present invention, a system for predicting the energy parameter value of the at least one wind farm is set up, in particular in terms of hardware and/or software, in particular in terms of programming, for carrying out a method described herein, and/or comprises:

means for detecting values of input parameters which comprise state parameters, control parameters and/or service parameters of the wind farm, in particular of the wind energy installation and/or of the grid connection point, and/or of at least one facility which is external to the wind farm; and

means for predicting the energy parameter value on the basis of the detected input parameter values and a relationship between the input parameters and the energy parameter learned by machine learning.

In one embodiment, the system, or its means, comprises:

means for determining at least one input parameter value on the basis of measured and/or predicted electrical, mechanical, thermal and/or meteorological data;

means for determining at least one input parameter value on the basis of a planned maintenance of the wind farm, in particular of the wind energy installation;

means for predicting the energy parameter value for at least two different time horizons and/or at least one time horizon of a maximum of 5 minutes and/or at least a time horizon of at least 5 minutes and of a maximum of 30 minutes and/or at least one time horizon of at least 15 minutes;

means for transmitting at least one input parameter value and/or the energy parameter value via a VPN gateway, in particular a web-based VPN, and/or to and/or from a cloud, in particular a virtual private cloud, in particular to and/or from the at least one wind farm, to and/or from the at least one facility which is external to the wind farm, to and/or from an artificial neural network and/or to a grid management system of the electricity grid;

means for continued machine learning of the relationship even during the operation of the at least one wind farm;

an artificial neural network that implements the relationship or is configured to implement the relationship or is used to implement the relationship; and/or

means for machine learning of the relationship on the basis of a comparison of detected values and predicted values of the energy parameter.

A means in the sense of the present invention can be constructed in terms of hardware and/or software, and may comprise in particular a processing unit, in particular a microprocessor unit (CPU) or a graphics card (GPU), in particular a digital processing unit, in particular a digital microprocessor unit (CPU), a digital graphics card (GPU) or the like, preferably connected to a memory system and/or a bus system in terms of data or signal communication, and/or may comprise one or more programs or program modules. The processing unit may be constructed so as to process instructions which are implemented as a program stored in a memory system, to acquire input signals from a data bus, and/or to output output signals to a data bus. A memory system may comprise one or more storage media, in particular different storage media, in particular optical media, magnetic media, solid state media and/or other non-volatile media. The program may be of such nature that it embodies the methods described herein, or is capable of executing them, such that the processing unit can execute the steps of such methods and thereby in particular predict the energy parameter value, or control the grid management system of the electricity grid on the basis of this. In one embodiment, a computer program product may comprise a storage medium, in particular a non-volatile storage medium, for storing a program or having a program stored thereon, and may in particular be such a storage medium, wherein execution of said program causes a system or a control system, in particular a computer, to carry out a method described herein, or one or more of its steps.

In one embodiment, one or more steps of the method, in particular all steps of the method, are carried out in a fully or partially automated manner, in particular by the system or its means.

In one embodiment, the system comprises the at least one wind farm, the electricity grid and/or its grid management system.

Further advantages and features will become apparent from the dependent claims and the example embodiments.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 illustrates a system for predicting an energy parameter value of at least one wind farm in accordance with an embodiment of the present invention; and

FIG. 2 illustrates a method for predicting the energy parameter value in accordance with an embodiment of the present invention.

### DETAILED DESCRIPTION

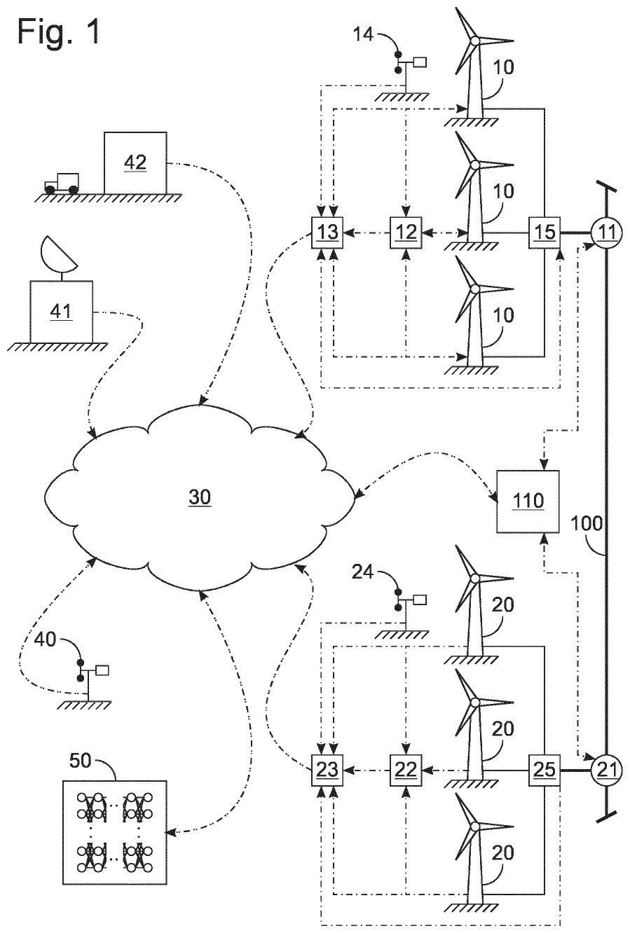

FIG. 1 shows, by way of example, two wind farms, each of which comprises a plurality of wind energy installations 10 and 20, respectively, and each of which is connected to an electricity grid 100 via a respective grid connection point 11 and 21.

State parameter values of the wind energy installations are transmitted to a respective control unit 12 or 22 and a respective interface 13 and 23 of the respective wind farm, to which the respective control unit 12 or 22 also transmits control parameters. Respective meteorological stations 14 or 24, condition monitoring systems and respective transformers 15 and 25 of the wind farms, if present, can also transmit state parameter values to the respective interface 13 and 23, as indicated in FIG. 1 by data arrows in which a dash alternates with a dot.

The interfaces 13, 23 transmit these input parameter values, which may be processed, for example filtered, integrated and/or classified, to a cloud 30 via VPN gateways of a web-based VPN, as indicated in FIG. 1 by data arrows in which a dash alternates with two dots.

Further facilities external to the wind farm, such as for example a meteorological station 40 external to the wind farm or a weather forecast (or a weather forecasting facility) 41 may also transmit input parameter values to the cloud 30 via VPN connections in a corresponding manner.

In addition, a service contractor 42 transmits service parameters relating to the wind farms to the cloud 30 via a VPN connection in a corresponding manner, such as points in time and durations of scheduled maintenance or the like.

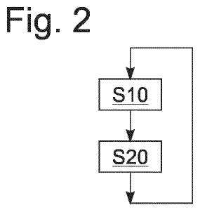

On the basis of these input parameter values transmitted from the cloud 30 in a step S10 (cf. FIG. 2), an artificial neural network 50 learns, by machine learning, a relationship between these input parameters and an energy parameter, for example an electrical power, which is, or which is able to be, fed into the electricity grid by the respective wind farm at its grid connection point at a later point in time, or at a point in time which is offset by a certain time horizon from a measurement point in time of the input parameter values. This machine learning is also continued during the operation of the wind farms.

On the basis of the input parameter values detected, or currently transmitted from the cloud 30 in step S10, as well as the relationship learned by machine learning, the artificial neural network 50 predicts, during operation, in a step S20 (cf. FIG. 2), the energy parameter value for one or more time horizons, i.e. for example the electrical power which is expected to be able to be made available in 15 minutes, or the like.

This energy parameter value is transmitted by the artificial neural network 50 to the cloud 30, from which a grid management system 110 of the electricity grid 100 receives, or retrieves, the corresponding predicted energy parameter values. This can control the electricity grid 100 based thereon, in particular with feedback, for example by demanding correspondingly more, or less, power at one of the grid connection points 11, 21, or the like. By means of this, in particular the grid stability of the electricity grid 100 can be improved.

Although example embodiments have been explained in the preceding description, it is to be noted that a variety of variations are possible. It is also to be noted that the example embodiments are merely examples which are not intended to limit the scope of protection, the applications and the structure in any way. Rather, the preceding description provides the skilled person with a guideline for the implementation of at least one example embodiment, whereby various modifications, in particular with regard to the function and the arrangement of the components described, can be made without departing from the scope of protection as it results from the claims and combinations of features equivalent to these.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10 wind energy installation
11 grid connection point
12 control unit
13 interface with VPN gateway
14 meteorological station
15 condition monitoring system and/or transformer
20 wind energy installation
21 grid connection point
22 control unit
23 interface with VPN gateway
24 meteorological station
25 condition monitoring system and/or transformer
30 cloud
40 meteorological station external to the wind farm
41 weather forecast (facility) external to the wind farm
42 service company for maintenance of at least one of the wind energy installations
50 artificial neural network
100 electricity grid
110 grid management system

What is claimed is:

1-9. (canceled)

10. A method of predicting an energy parameter value of at least one wind farm that is connected to an electricity grid via a grid connection point and which includes at least one wind energy installation, the method comprising:
detecting values of input parameters which comprise at least one of state parameters, control parameters, or service parameters of at least one of the wind farm or at least one facility external to the wind farm; and
predicting the energy parameter value on the basis of the detected input parameter values and a machine-learned relationship between the input parameters and the energy parameter.

11. The method of claim 10, wherein the input parameters are parameters of at least one of the wind energy installation or the grid connection point.

12. The method of claim 10, wherein at least one input parameter value is determined on the basis of at least one of measured or predicted electrical, mechanical, thermal, and/or meteorological data.

13. The method of claim 10, wherein at least one input parameter value is determined on the basis of a planned maintenance of the wind farm, in particular of the wind energy installation.

14. The method of claim 13, wherein at least one input parameter value is determined on the basis of a planned maintenance of the wind energy installation.

15. The method of claim 10, wherein the energy parameter value is predicted for at least one of:
at least two different time horizons;
at least one time horizon of a maximum of 5 minutes;
at least a time horizon of at least 5 minutes and of a maximum of 30 minutes; or
at least one time horizon of at least 15 minutes.

16. The method of claim 10, further comprising at least one of:
transmitting at least one of at least one input parameter or the energy parameter value via a VPN gateway; or
transmitting at least one of at least one input parameter or the energy parameter value to and/or from a cloud.

17. The method of claim 16, wherein at least one of:
transmitting via a VPN gateway comprises transmitting via a web-based VPN; or
transmitting to and/or from a cloud comprises transmitting to and/or from a virtual private cloud.

18. The method of claim 16, wherein the at least one input parameter or the energy parameter value is at least one of:
transmitted to and/or from the at least one wind farm;
transmitted to and/or from the at least one facility which is external to the wind farm;
transmitted to and/or from an artificial neural network; or
transmitted to a grid management system of the electricity grid.

19. The method of claim 10, further comprising at least one of:
continuing to learn the relationship between the input parameters and the energy parameter by machine learning, even during the operation of the at least one wind farm; or
implementing the relationship with the aid of an artificial neural network.

20. The method of claim 10, wherein the relationship is learned by machine learning on the basis of a comparison of detected values and predicted values of the energy parameter.

21. A system for predicting an energy parameter value of at least one wind farm that is connected to an electricity grid via a grid connection point and which comprises at least one wind energy installation, the system comprising:
means for detecting values of input parameters which comprise at least one of state parameters, control parameters, or service parameters of at least one of the wind farm or at least one facility external to the wind farm; and
means for predicting the energy parameter value on the basis of the detected input parameter values and a machine-learned relationship between the input parameters and the energy parameter.

22. The system of claim 21, wherein the input parameters are parameters of at least one of the wind energy installation or the grid connection point.

23. A computer program product comprising a program code stored on a non-transitory, machine-readable storage medium, the program code configured to, when executed by a computer, cause the computer to:
detect values of input parameters which comprise at least one of state parameters, control parameters, or service parameters of at least one of the wind farm or at least one facility external to the wind farm; and
predict the energy parameter value on the basis of the detected input parameter values and a machine-learned relationship between the input parameters and the energy parameter.

24. The system of claim 23, wherein the input parameters are parameters of at least one of the wind energy installation or the grid connection point.
